(19) United States
(12) Patent Application Publication
(10) Pub. No.: US 2026/0129719 A1
(43) Pub. Date: May 7, 2026

(54) Strain-Insensitive Heating Element, Strain-Insensitive Heating Element Manufacturing Method, and Wearable Heating Device

(71) Applicant: UIF (University Industry Foundation), Yonsei University, Seoul (KR)

(72) Inventors: Jong Baeg KIM, Goyang-si (KR); Sang Jun SIM, Seoul (KR); Kyu Bin BAE, Seoul (KR)

(73) Assignee: UIF (University Industry Foundation), Yonsei University, Seoul (KR)

(21) Appl. No.: 18/955,094

(22) Filed: Nov. 21, 2024

(30) Foreign Application Priority Data
Nov. 28, 2023 (KR) 10-2023-0167836

(51) Int. Cl. H05B 3/34; H05B 3/03; H05B 3/14

(52) U.S. Cl. CPC H05B 3/34; H05B 3/03; H05B 3/145; H05B 2203/007; H05B 2203/017

(57) ABSTRACT

A strain-insensitive heater, a method for manufacturing the strain-insensitive heater, and a wearable heating device including the same are disclosed. The strain-insensitive heater includes a substrate; a heating portion formed on the substrate; a first electrode formed on the substrate and contacting the heating portion; and a second electrode formed on the substrate and contacting the heating portion, wherein the second electrode is spaced apart from the first electrode, wherein the heating portion includes an array of vertically aligned carbon nanotubes (VACNTs) arranged horizontally on the substrate, wherein a longitudinal axis of each of the VACNTs is oriented in a perpendicular manner to a surface of the substrate.

### CROSS-REFERENCE TO RELATED APPLICATION

This application claims priority to Korean Patent Application No. 10-2023-0167836 filed on Nov. 28, 2023 in the Korean Intellectual Property Office, and all the benefits accruing therefrom under 35 U.S.C. 119, the contents of which are herein incorporated by reference in its entirety.

### BACKGROUND

### Field

The present disclosure relates to a strain-insensitive heater, a method for manufacturing the strain-insensitive heater, and a wearable heating device including the same.

### Description of Related Art

Researchers are seeking various methods to improve stretchability of a stretchable heating portion while maintaining heating performance of the stretchable heating portion. For example, a liquid metal-based stretchable heating portion with a strain of 100% or greater includes a complex pattern and employs a Kirigami structure utilizing a polyimide sheet coated with silver nanowires. However, these existing methods have the disadvantage of requiring time-consuming processes such as direct printing or laser cutting.

### SUMMARY

In contrast thereto, the present disclosure proposes a stretchable heating portion that may be manufactured using vertically aligned carbon nanotubes (VACNTs) and without a complex patterning process. This stretchable heating portion has the advantage of maintaining constant heating performance due to almost no change in resistance even under strain.

Thus, a purpose of the present disclosure is to provide a flexible and durable heater suitable for a wearable device. To this end, a heating portion using vertically aligned carbon nanotubes (VACNTs), a flexible substrate, an electrode using a flexible conductive material, and a passivation layer including a polymer are used. Through this innovative configuration, the heater of the present disclosure maintains consistent heating performance even under strain and repeated use, and overcomes the limitations in terms of flexibility and durability of the existing heaters. The high conductivity and mechanical flexibility of the VACNTs improve the efficiency and stretchability of the heater, and the flexible substrate and the electrode made of the flexible and conductive material enhance durability of the heater. The polymer passivation layer protects the electrode and enhances stability of the heater. As a result, the strain-insensitive heater of the present disclosure may be applied to various wearable devices such as medical heating patches, sportswear, wearable refrigerators, and wearable heating devices, and may increase a possibility of commercialization of wearable technology.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A first aspect of the present disclosure provides a strain-insensitive heater comprising: a substrate; a heating portion formed on the substrate; a first electrode formed on the substrate and contacting the heating portion; and a second electrode formed on the substrate and contacting the heating portion, wherein the second electrode is spaced apart from the first electrode, wherein the heating portion includes an array of vertically aligned carbon nanotubes (VACNTs) arranged horizontally on the substrate, wherein a longitudinal axis of each of the VACNTs is oriented in a perpendicular manner to a surface of the substrate.

In accordance with some embodiments of the strain-insensitive heater, the substrate is a flexible substrate.

In accordance with some embodiments of the strain-insensitive heater, each of the first electrode and the second electrode includes a flexible conductive material.

In accordance with some embodiments of the strain-insensitive heater, the first electrode or the second electrode includes a liquid metal.

In accordance with some embodiments of the strain-insensitive heater, the first electrode and the second electrode are covered with a passivation layer including a polymer.

In accordance with some embodiments of the strain-insensitive heater, when the heating portion has been stretched at a strain of 350% in the horizontal direction of the substrate, the strain-insensitive heater maintains 95% to 105% of heating performance thereof in a non-stretched state of the heating portion.

In accordance with some embodiments of the strain-insensitive heater, when stretching of the heating portion at a strain of 200% in the horizontal direction of the substrate has been repeated 10,000 times, the strain-insensitive heater maintains 95% to 105% of heating performance thereof before the repetition of the stretching.

In accordance with some embodiments of the strain-insensitive heater, the flexible substrate is a wrinkled flexible substrate.

A second aspect of the present disclosure provides a method for manufacturing a strain-insensitive heater, the method comprising: providing a substrate; forming a first electrode and a second electrode on the substrate such that the first electrode and the second electrode are spaced apart from each other; and forming a heating portion on the substrate so as to contact the first electrode and the second electrode, wherein forming the heating portion includes transferring an array of vertically aligned carbon nanotubes (VACNTs) onto the substrate such that the vertically aligned carbon nanotubes (VACNTs) are arranged horizontally on the substrate, wherein a longitudinal axis of each of the VACNTs is oriented in a perpendicular manner to a surface of the substrate.

In accordance with some embodiments of the method for manufacturing the strain-insensitive heater, the substrate is a flexible substrate.

In accordance with some embodiments of the method for manufacturing the strain-insensitive heater, each of the first electrode and the second electrode includes a flexible conductive material.

In accordance with some embodiments of the method for manufacturing the strain-insensitive heater, the first electrode or the second electrode includes a liquid metal.

In accordance with some embodiments of the method for manufacturing the strain-insensitive heater, the method for manufacturing the strain-insensitive heater further comprises forming a passivation layer on the first electrode and the second electrode, wherein the passivation layer includes a polymer.

In accordance with some embodiments of the method for manufacturing the strain-insensitive heater, transferring the array of the vertically aligned carbon nanotubes (VACNTs) includes: applying an uncured polymer as an adhesive layer onto the substrate; and transferring the array of the vertically aligned carbon nanotubes onto the adhesive layer.

In accordance with some embodiments of the method for manufacturing the strain-insensitive heater, the flexible substrate is a wrinkled flexible substrate.

A third aspect of the present disclosure provides a wearable heating device comprising: the strain-insensitive heater as described above; and a power source for applying electrical power to the strain-insensitive heater.

The strain-insensitive heater of the present disclosure has high flexibility and durability, and may be applicable to various application fields of wearable devices. The use of the vertically aligned carbon nanotubes (VACNTs) increases the flexibility of the heater while providing high conductivity thereof. In addition, the application of the flexible substrate and the electrode made of the flexible conductive material enhances the durability of the heater. The passivation layer made of the polymer protects the electrode and further improves the stability and durability of the heater, thereby maintaining consistent heating performance even under strain and repeated use. Thanks to these characteristics, the heater of the present disclosure may be applied to various wearable devices such as medical heating patches, sportswear, wearable refrigerators, and wearable heating device, and may increase a possibility of commercialization of wearable technology.

The strain-insensitive heater of the present disclosure includes the vertically aligned carbon nanotubes (VACNTs) to demonstrate the effect of very small resistance change during stretching. Since each of the VACNTs are aligned in the perpendicular manner to the substrate, electrical connections between carbon nanotubes are maintained even under physical deformations such as strain or bending. Thus, the heater may exhibit almost no resistance change even under high strains of 150% to 350%, and thus may maintain constant heating performance. Due to these characteristics, the heater may maintain consistent heating performance in environments that require frequent stretching, such as wearable devices, thereby achieving stable heat management.

In addition to the effects as described above, specific effects in accordance with the present disclosure will be described together with following detailed descriptions for carrying out the disclosure.

### BRIEF DESCRIPTION OF DRAWINGS

FIG. 1 illustrates a fabrication method and a structure of a strain-insensitive stretchable heater of the present disclosure.

FIG. 2 illustrates a scanning electron microscope image and an operating principle of the fabricated strain-insensitive stretchable heater.

FIG. 3 illustrates heating performance change according to strain and heating performance change after repeated strains.

FIG. 4 illustrates a result of monitoring heating performance of the heater of the present disclosure after attaching the heater of the present disclosure to a finger.

FIGS. 5A to 5F exhibits heating characteristics of the proposed stretchable heater under a strain condition. FIG. 5A shows a temperature of the heater with and without the wrinkled structure. The stretchable heater with the wrinkled structure exhibits almost no change in an operating temperature even at 350% strain. This high stretchability is due to the folded structure of the integrated VACNTs are, and the contact between the VACNTs is maintained even when being stretched. FIG. 5B shows an infrared (IR) image of the stretchable heater at various strains (0%, 200%, 350%). FIG. 5C shows a comparison between the heater of the present disclosure and a recently reported stretchable heater. FIG. 5D and FIG. 5E show SEM images of the heater in the initial state and at 350% strain, respectively. FIG. 5F shows an operating temperature of the heater after repeated strain cycles at 200% strain. The temperature change is smaller than 5% even after 10,000 strains.

FIG. 6 shows an example of a heater using a wrinkled flexible substrate.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in the present disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations.

The features of the various embodiments of the present disclosure may be partially or entirely combined with each other, and may be technically associated with each other or operate with each other. The embodiments may be implemented independently of each other and may be implemented together in an association relationship.

In interpreting a numerical value, the value is interpreted as including an error range unless there is no separate explicit description thereof. In the context of the present disclosure, the term “about” may mean about ±1%, about ±2%, about ±3%, about ±4%, about ±5%, about ±6%, about ±7%, about ±8%, about ±9%, or about ±10% of a value stated herein.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description as set forth below have been selected as being general and universal in the related technical field. However, there may be other terms than the terms depending on the development and/or change of technology, convention, preference of technicians, etc. Therefore, the terms used in the description as set forth below should not be understood as limiting technical ideas, but should be understood as examples of the terms for illustrating embodiments.

Further, in a specific case, a term may be arbitrarily selected by the applicant, and in this case, the detailed meaning thereof will be described in a corresponding description period. Therefore, the terms used in the description as set forth below should be understood based on not simply the name of the terms, but the meaning of the terms and the contents throughout the Detailed Descriptions.

A strain-insensitive heater according to an embodiment of the present disclosure includes: a substrate; a heating portion formed on the substrate; a first electrode formed on the substrate and contacting the heating portion; and a second electrode formed on the substrate and contacting the heating portion, wherein the second electrode is spaced apart from the first electrode, wherein the heating portion includes an array of vertically aligned carbon nanotubes (VACNTs) arranged horizontally on the substrate, wherein a longitudinal axis of each of the VACNTs is oriented in a perpendicular manner to a surface of the substrate.

The role of the substrate is to physically support and stably maintain the components of the heater. The substrate may play an important role in structurally stabilizing the heating portion and the electrodes and maintaining the electrical connections therebetween. Furthermore, the substrate may be a key component that provides flexibility and durability of the heater, thus making the heater suitable for the wearable devices.

In one embodiment, the substrate may be a flexible substrate. Selecting the substrate as the flexible substrate may allow the heater to be easily adapted to various shapes and movements required when the heater is applied to a wearable device. The flexible substrate provides the heater with the ability to adhere to the user's body or other surface while also withstanding physical deformation such as bending or stretching. In this way, the heater may be applied to various types of wearable products such as fabrics, medical patches, and sports and fitness wearable devices.

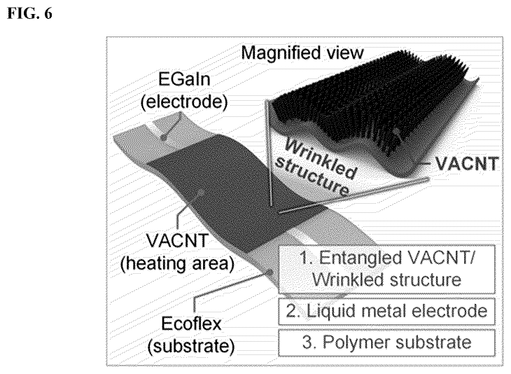

In one embodiment, the flexible substrate may be a wrinkled flexible substrate. In the context of the present disclosure, the term “wrinkled flexible substrate” means that a wrinkled structure is formed in a surface of the substrate so that the performance of the heater is not degraded and may be maintained at a constant level even under strain. This wrinkled structure may help to alleviate mechanical stress that occurs under strain, thereby allowing the heater to operate stably even under high strain. Furthermore, the wrinkled structure may further enhance the flexibility and durability of the heater, thereby enabling a design of the heater suitable for various wearable devices. An example of the wrinkled flexible substrate is illustrated in FIG. 6.

The role of the heating portion is to convert electrical energy into thermal energy. For example, the heating portion may emit heat under the resistance heat generated by the flow of current therein. This heat may be uniformly distributed and controlled according to the needs of the wearable device. In the present disclosure, the vertically aligned carbon nanotubes (VACNTs)-based structure of the heating portion is designed to minimize change in the heating performance even under strain or bending. This may enhance the stretchability and durability of the wearable device.

In the context of the present disclosure, the meaning of the vertically aligned carbon nanotube (VACNTs) refers to carbon nanotubes aligned in a perpendicular manner to the substrate. The VACNTs are a core part of the heater and play a role in improving the electrical and thermal properties thereof. The VACNTs have particularly high conductivity and thermal conductivity, which may contribute to the efficient heat generation and transfer of the heating portion. Furthermore, the vertically aligned structure provides mechanical flexibility, which is an important characteristic when the heater is applied to a stretchable or flexible wearable device. Despite physical deformation such as strain or bending, VACNTs may have the ability to maintain electrical and thermal performance. This effect will be more clearly apparent in the following Examples.

The role of the first electrode and the second electrode is to provide an electrical connection to the heater to the power source and to enable the flow of current in the heater. These electrodes may be essential for transmitting an electrical signal or power to the heating portion to generate the heat. The first electrode and the second electrode control the flow of current to the heating portion, thereby controlling the temperature and heat output of the heating portion. Furthermore, these electrodes may be designed to maximize the electrical efficiency of the heater and play an important role in wearable devices. For example, when the heater is applied to the wearable devices that require flexibility, each of the electrodes may be made of the flexible material so that the heater may maintain stable electrical performance without being affected under the movement of the device.

In one embodiment, each of the first electrode and the second electrode may include a flexible conductive material. The use of the flexible conductive material increases the overall flexibility of the heater and thus makes the heater suitable for various applications of the wearable device. The flexible conductive material may provide comfort to the user when the heater is attached to the skin or other soft surface of the user, and may protect the electrode from stress or deformation due to the movement of the user. Thus, the heater of the present disclosure may be integrated into various flexible surfaces such as clothing, medical patches, and fitness bands. Furthermore, the flexible conductive material helps the electrode maintain electrical connection even when the heater is bent or stretched.

In one embodiment, the first electrode or the second electrode may include a liquid metal. Using the liquid metal may further improve the flexibility and electrical performance of the heater. The liquid metal is a material that has high conductivity and flexible ability at the same time. This may help the heater to cope well with physical deformation such as bending or stretching, while maintaining effective electrical connection. The electrode including the liquid metal is particularly advantageous for applications of the heater to the wearable devices, which may play an important role in the applications where the shape of the device changes according to the user's movement.

The strain-insensitive heater according to the present disclosure having the above-described configuration may be highly suitable for use in various wearable applications. The heater including the flexible substrate, the VACNT-based heating portion, the electrodes made of the flexible conductive material, or the electrodes made of the liquid metal as needed has a high level of stretchability, durability, and efficient heat transfer capability. These characteristics may be particularly important for garments, medical patches, fitness and sports wearable devices, etc., where the heater should be in close contact with the user's body.

The heater of the present disclosure does not exclude inclusion of additional components. In one embodiment, the first electrode and the second electrode may be covered with the passivation layer including a polymer. In the context of the present disclosure, the passivation layer refers to a polymer layer applied onto the electrodes to protect the electrodes and improve the stability and durability of the heater. The passivation layer may serve to protect the electrodes from environmental factors, mechanical wear, chemical corrosion, or electrical overload. This layer acts as an important factor in improving the reliability and life of the heater. Especially in the wearable devices, the passivation layer helps the electrodes to function stably even under repeated use of the device and various environmental conditions. The passivation layer may be made of a polymer material, which may provide flexibility and chemical resistance to meet various requirements of wearable devices.

In accordance with some embodiments of the strain-insensitive heater, when the heating portion has been stretched at a strain of 150% in the horizontal direction of the substrate, the strain-insensitive heater may maintain 95% to 105% of heating performance thereof in a non-stretched state of the heating portion. In accordance with some embodiments of the strain-insensitive heater, when stretching of the heating portion at a strain of 150% in the horizontal direction of the substrate has been repeated 10,000 times, the strain-insensitive heater maintains 95% to 105% of heating performance thereof before the repetition of the stretching. In accordance with some embodiments of the strain-insensitive heater, when the heating portion has been stretched at a strain of 350% in the horizontal direction of the substrate, the strain-insensitive heater may maintain 95% to 105% of heating performance thereof in a non-stretched state of the heating portion. In accordance with some embodiments of the strain-insensitive heater, when stretching of the heating portion at a strain of 200% in the horizontal direction of the substrate has been repeated 10,000 times, the strain-insensitive heater maintains 95% to 105% of heating performance thereof before the repetition of the stretching. The improved effect of the heater opens up new possibilities in the field of wearable technology. The flexibility, durability, and consistent heating performance of the heater even after repeated use enable applications of the heater to various fields such as healthcare, sports, and daily wear, thereby making an important contribution to the development of wearable technology. This effect will be made clear based on Examples as described below.

Furthermore, a method for manufacturing a strain-insensitive heater according to an embodiment of the present disclosure may include: a step of providing a substrate; an electrode formation step of forming a first electrode and a second electrode on the substrate such that the first electrode and the second electrode are spaced apart from each other; and a heating portion forming step of forming a heating portion on the substrate so as to contact the first electrode and the second electrode, wherein forming the heating portion includes transferring an array of vertically aligned carbon nanotubes (VACNTs) onto the substrate such that the vertically aligned carbon nanotubes (VACNTs) are arranged horizontally on the substrate, wherein a longitudinal axis of each of the VACNTs is oriented in a perpendicular manner to a surface of the substrate.

The role of the electrode formation step is to create and define an electrical path within the heater. In this step, the first electrode and the second electrode are formed on the substrate, and these electrodes serve to transmit electrical signals or power to the heating portion. The position and arrangement of the electrodes are important factors that determine the electrical characteristics and heating pattern of the heater. The electrodes supply electrical current to the heating portion, and the flow of the current may generate resistive heat generated within the heating portion. In the electrode formation step, the selection of the electrode material, the electrode thickness, the electrode shape, the arrangement of the electrodes etc. are important considerations. For example, when the heater is used in a flexible wearable device, the electrode material may be selected as a material having flexibility and high electrical conductivity. Furthermore, since the second electrode is spaced apart from the first electrode, an appropriate spacing between the electrodes may be maintained to prevent electrical interference and short circuit therebetween, such that the overall stability and efficiency of the heater may be improved.

The role of the heating portion forming step is to form the heating portion which directly contacts the electrodes and generates the heat. In this step, the heating portion as a core functional component of the heater is created by transferring the vertically aligned carbon nanotubes (VACNTs) to the substrate. The heating portion may play a role in generating the heat (e.g., resistance heat) when the current flows therein, and controlling the heat required for the wearable device.

The use of VACNTs in the heating portion forming step may maximize the thermal efficiency and electrical characteristics of the heater. The vertical alignment of the CNTs in the VACNTs may help heat and electricity to be distributed evenly and effectively within the heater. This may ensure that the heater operates stably in various wearable applications where temperature control is important. Furthermore, the VACNTs may provide mechanical flexibility along with the high conductivity, thereby making the heater suitable for stretchable or flexible wearable devices.

In one embodiment, the substrate may be prepared as a flexible substrate. In one embodiment, each of the first electrode and the second electrode may be made of a flexible conductive material. In one embodiment, each of the first electrode or the second electrode may be made of a liquid metal.

In one embodiment, the method for manufacturing the strain-insensitive heater may further include a passivation layer formation step of forming the passivation layer including a polymer on the first electrode and the second electrode so as to cover the first electrode and the second electrode.

In accordance with some embodiments of the method for manufacturing the strain-insensitive heater, transferring the array of the vertically aligned carbon nanotubes (VACNTs) include: applying an uncured polymer as an adhesive layer onto the substrate; and transferring the array of the vertically aligned carbon nanotubes onto the adhesive layer. The adhesive layer helps the VACNTs to be stably attached to the substrate and facilitates the transfer process. The use of the uncured polymer may serve to simplify the transfer process of the VACNTs and strengthen the attachment of the VACNTs to the substrate. This makes the manufacturing process more efficient and simpler, thereby increasing the economy and practicality in mass production of the heater.

In accordance with some embodiments of the method for manufacturing the strain-insensitive heater, the flexible substrate is the wrinkled flexible substrate.

Furthermore, a wearable heating device according to the embodiment of the present disclosure may include the strain-insensitive heater as described above; and a power source for applying electrical power to the strain-insensitive heater. Furthermore, a wearable heating device according to an embodiment of the present disclosure may include the strain-insensitive heater manufactured using the method for manufacturing the strain-insensitive heater; and a power source that applies electrical power to the strain-insensitive heater.

The role of the power source is to provide and control the electrical power required for the strain-insensitive heater. The power source is an important component of the wearable heating device and may directly affect the performance of the heater and the user's experience. The power source should be able to stably supply the power to the heater and control the heating amount as needed. The power source may include a battery, a charging circuit, a power management system, and a user interface. The battery stores therein the electrical power for continuous operation of the wearable device. The charging circuit efficiently charges the battery. The power management system may control the power delivery to the heater and adjust the heating level to suit the user's needs. The user may control the temperature of the heater and monitor the status of the device through the user interface (e.g., buttons, touchscreen, app).

The wearable heating device according to an embodiment of the present disclosure may include the strain-insensitive heater and the power source and thus may provide user-customized heat management and comfortable wearing experience to the user. The wearable heating device is designed to be suitable for use in various environments and situations, and may be usefully utilized in the fields of healthcare, sports and fitness, and daily wear.

Hereinafter, Examples of the present disclosure are described in detail. However, the Examples as described as set forth below are only some embodiments of the present disclosure, and the scope of the present disclosure is not limited to the Examples as set forth below.

The present disclosure discloses a structure of a strain-insensitive stretchable heater using the vertically aligned carbon nanotubes and a method for manufacturing the same.

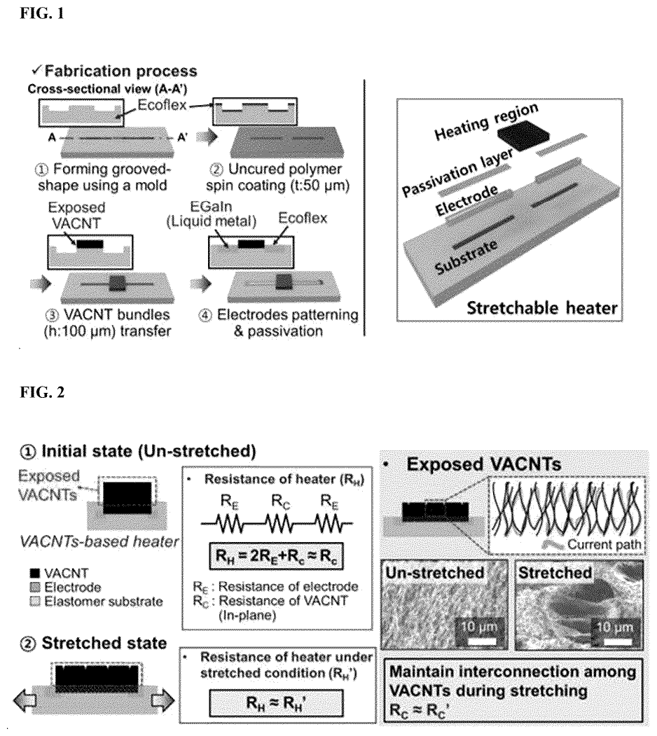

FIG. 1 illustrates the method for manufacturing the strain-insensitive stretchable heater of the present disclosure and the structure thereof. First, a polymer having a groove defined therein is fabricated using a mold, thereby preparing the substrate. Then, a liquid metal to be used as the electrode is filled into the groove. Afterwards, the vertically aligned carbon nanotubes as prepared in a chemical vapor deposition (CVD) process are transferred onto an area of the substrate between the two electrodes. The transfer process is performed at room temperature, and a thinly coated and uncured polymer is used as an adhesive in this transfer process. After the vertically aligned carbon nanotubes have been transferred to the substrate, the liquid metal is coated with the polymer layer as the passivation layer and cured to passivate the device.

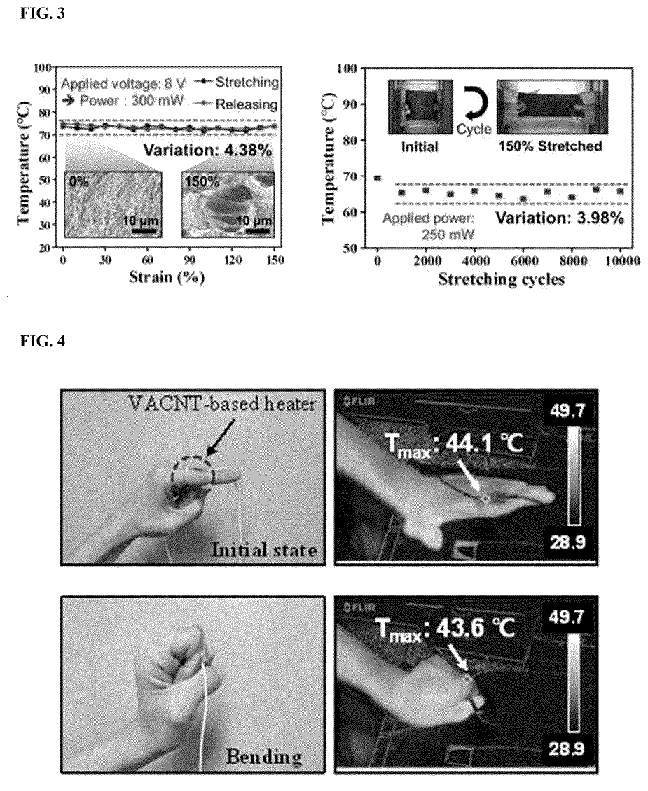

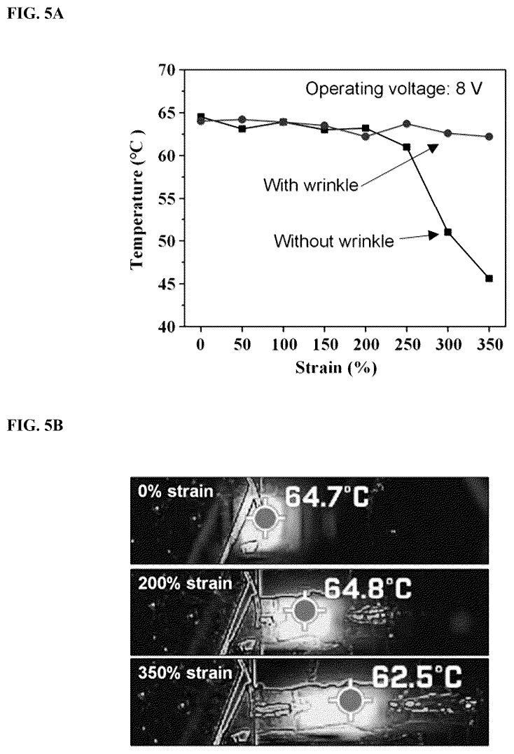

FIG. 2 illustrates a scanning electron microscope image and an operating principle of the fabricated strain-insensitive stretchable heater. FIG. 3 illustrates heating performance change according to strain and heating performance change after repeated strains. When voltage is applied to the heater, the vertically aligned carbon nanotubes have much higher resistance than that of the liquid metal and thus generate the heat in the carbon nanotube region due to the Joule heating effect. All elements that constitute the device have low rigidity and are easily deformed when being stretched. When being deformed in the horizontal direction, the vertically aligned carbon nanotubes maintain an intertwined structure, and maintain the formed current path. That is, as shown in FIG. 3, the heating performance of the heating portion does not change significantly even under strain. Thus, the strain-insensitive stretchable heater that is not affected under the repeated stretching may be manufactured.

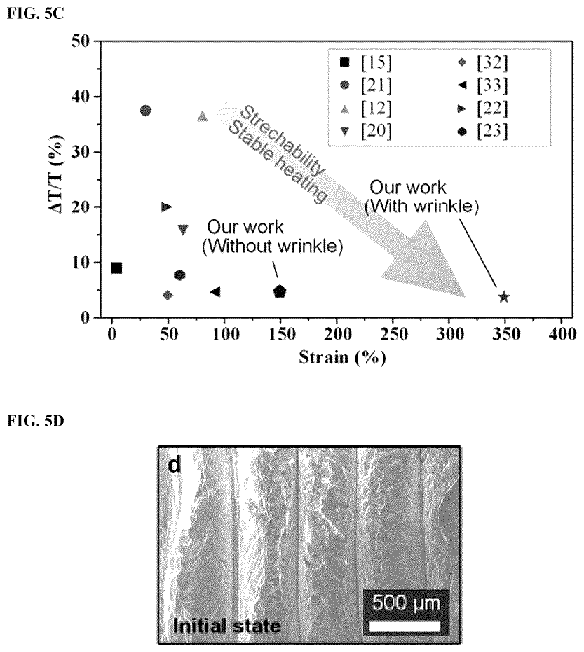

FIG. 4 illustrates a result of monitoring heating performance of the heater of the present disclosure after attaching the heater of the present disclosure to a finger. An anisotropic conductor as manufactured in the method presented in the present disclosure may also be used as an artificial thermal sensation reproduction device for a haptic interface. As shown in FIG. 4, the developed device is stretchable, and thus may be attached to a joint area of the human body without interfering with the movement of the joint. In addition, the device of the present disclosure exhibits reliable heating performance even under strain occurring in the joint, and thus may be expected to be applied to thermal sensation reproduction and thermal therapy equipment.

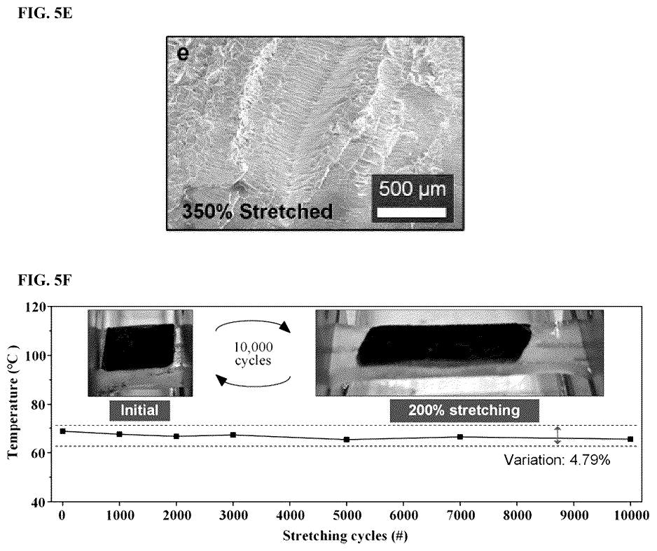

FIG. 5 exhibits heating characteristics of the proposed stretchable heater under a strain condition.

FIG. 5A is a diagram showing how the temperature of the heater changes according to the strain with/without the wrinkle. Referring to FIG. 5A, the temperature change of the heating portion may be observed until the strain reaches 350% under the operating voltage of 8 V. When the wrinkle is present, the temperature is maintained almost constant even when the strain increases. However, when there are no wrinkles, the temperature decreases rapidly when the strain exceeds about 250%. Through FIG. 5A, it may be identified that the heater with the wrinkle maintains the temperature stably even at a high strain of 350%, while the heater without the wrinkle has deterioration in the heating performance at the high strain. The heater of the present disclosure exhibits the advantage that the wrinkled structure plays a role in enhancing the strain insensitivity of the heater.

FIG. 5B is a diagram showing the result of measuring the heating performance based on infrared (IR) images of the heater at strains of 0%, 200%, and 350%. Referring to FIG. 5B, it may be identified that the heating temperature of the device is maintained at 64.7 degrees C at 0% strain, 64.8 degrees C at 200% strain, and 62.5 degrees C at 350% strain. This suggests that the heating performance of the heater hardly changes even when the strain increases. Through FIG. 5B, it may be identified that the heater of the present disclosure does not exhibit a significant decrease in the heating performance even at the high strain. This proves the excellent strain insensitivity of the heater as presented by the present disclosure, and suggests the advantage that the heater provides stable heating performance in wearable devices.

FIG. 5C is a diagram showing the result of comparing the heating performance change of the heater of the present disclosure according to the varying strain with the heating performance change of the heater of the conventional case according to the varying strain. Referring to FIG. 5C, the heater with the wrinkled structure marked as “Our work (With wrinkle)” exhibits excellent stretchability and stable heating performance at a heating performance change rate (ΔT/T) smaller than or equal to 5% at 350% strain, compared to the heater of the conventional case. On the other hand, the heater without the wrinkle labeled as “Our work (Without wrinkle)” exhibits relatively lower stability at the strain below 100%. Through FIG. 5C, it may be identified that the heater with the wrinkle of the present disclosure maintains excellent stretchability and stable heating performance compared to the conventional heater. This demonstrates the excellent strain insensitivity of the heater of the present disclosure suitable for the wearable devices and suggests the advantage that the heater of the present disclosure provides stable heating performance in various applications.

FIG. 5D and FIG. 5E are diagrams showing scanning electron microscope (SEM) images of the surface of the heater in the initial state and the 350% strain state, respectively. Referring to FIG. 5D, in the initial state, the surface of the heater is maintained as non-deformed, and the structure of the vertically aligned carbon nanotubes is clearly visible. This exhibits a stable structure of the heater in the state where the heater is not deformed. Referring to FIG. 5E, it may be identified that the network of the carbon nanotubes is maintained and the structural continuity of the surface of the device is secured even when the heater has been stretched to 350%. This suggests that the heater of the present disclosure may maintain consistent performance without structural deformation even under the great strain. Through FIG. 5D and FIG. 5E, it may be identified that the heater of the present disclosure maintains the continuity of the surface structure even under the high strain, so that the heating performance thereof is not affected. This proves that the heater of the present disclosure provides excellent performance that satisfies both stretchability and durability required for wearable devices.

FIG. 5F is a diagram showing the result of measuring the change in the heating temperature during 10,000 repeated stretching cycles at the strain of 200%. Referring to FIG. 5F, it may be identified that the heater maintains a constant temperature of approximately 65° C. both in the initial state and the 200% strain state, and the temperature change during 10,000 stretching cycles is only approximately 4.79%. This suggests that the heating performance of the heater of the present disclosure hardly changes even under highly repeated stretching. Through FIG. 5F, it may be identified that the heater of the present disclosure maintains stable heating performance even in a long-term, repetitive strain environment. Thus, the reliability and durability of the heater to the applications that require continuous strain and use, such as the wearable devices may be secured.

The advantages of the strain-insensitive stretchable heater proposed in the present disclosure over the heaters in the existing research and inventions are as follows: (1) Integrating the high-temperature synthesized vertically aligned carbon nanotubes into the polymer substrate using a low-temperature transfer process. (2) Maintaining heating performance even under the high strain through the mutually formed network of the vertically aligned carbon nanotubes without a complex patterning process. (3) Development of the stretchable heater made of the flexible materials such as the liquid metal of the electrodes and the polymer of the flexible substrate.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. A strain-insensitive heater comprising:
a substrate;
a heating portion formed on the substrate;
a first electrode formed on the substrate and contacting the heating portion; and
a second electrode formed on the substrate and contacting the heating portion, wherein the second electrode is spaced apart from the first electrode,
wherein the heating portion includes an array of vertically aligned carbon nanotubes (VACNTs) arranged horizontally on the substrate, wherein a longitudinal axis of each of the VACNTs is oriented in a perpendicular manner to a surface of the substrate.

2. The strain-insensitive heater of claim 1, wherein the substrate is a flexible substrate.

3. The strain-insensitive heater of claim 1, wherein each of the first electrode and the second electrode includes a flexible conductive material.

4. The strain-insensitive heater of claim 3, wherein the first electrode or the second electrode includes a liquid metal.

5. The strain-insensitive heater of claim 3, wherein the first electrode and the second electrode are covered with a passivation layer including a polymer.

6. The strain-insensitive heater of claim 1, wherein when the heating portion has been stretched at a strain of 350% in the horizontal direction of the substrate, the strain-insensitive heater maintains 95% to 105% of heating performance thereof in a non-stretched state of the heating portion.

7. The strain-insensitive heater of claim 1, wherein when stretching of the heating portion at a strain of 200% in the horizontal direction of the substrate has been repeated 10,000 times, the strain-insensitive heater maintains 95% to 105% of heating performance thereof before the repetition of the stretching.

8. The strain-insensitive heater of claim 2, wherein the flexible substrate is a wrinkled flexible substrate.

9. A method for manufacturing a strain-insensitive heater, the method comprising:
providing a substrate;
forming a first electrode and a second electrode on the substrate such that the first electrode and the second electrode are spaced apart from each other; and
forming a heating portion on the substrate so as to contact the first electrode and the second electrode,
wherein forming the heating portion includes transferring an array of vertically aligned carbon nanotubes (VACNTs) onto the substrate such that the vertically aligned carbon nanotubes (VACNTs) are arranged horizontally on the substrate,
wherein a longitudinal axis of each of the VACNTs is oriented in a perpendicular manner to a surface of the substrate.

10. The method for manufacturing the strain-insensitive heater of claim 9, wherein the substrate is a flexible substrate.

11. The method for manufacturing the strain-insensitive heater of claim 9, wherein each of the first electrode and the second electrode includes a flexible conductive material.

12. The method for manufacturing the strain-insensitive heater of claim 11, wherein the first electrode or the second electrode includes a liquid metal.

13. The method for manufacturing the strain-insensitive heater of claim 9, wherein the method for manufacturing the strain-insensitive heater further comprises forming a passivation layer on the first electrode and the second electrode, wherein the passivation layer includes a polymer.

14. The method for manufacturing the strain-insensitive heater of claim 9, wherein transferring the array of the vertically aligned carbon nanotubes (VACNTs) includes:
applying an uncured polymer as an adhesive layer onto the substrate; and
transferring the array of the vertically aligned carbon nanotubes onto the adhesive layer.

15. The method for manufacturing the strain-insensitive heater of claim 10, wherein the flexible substrate is a wrinkled flexible substrate.

16. A wearable heating device comprising:
the strain-insensitive heater of claim 1; and
a power source for applying electrical power to the strain-insensitive heater.
